(19) United States
(12) Patent Application Publication
(10) Pub. No.: US 2013/0022893 A1
(43) Pub. Date: Jan. 24, 2013

(54) COMPOSITION, COMPOSITE MEMBRANE PREPARED FROM COMPOSITION, FUEL CELL INCLUDING THE COMPOSITE MEMBRANE, AND METHOD OF MANUFACTURING THE COMPOSITE MEMBRANE

(71) Applicants: PIL-WON HEO, YONGIN-SI (KR); TAKASHI HIBINO, NAGOYA (JP); YONG-CHENG JIN, TOKYO (JP)

(72) Inventors: PIL-WON HEO, YONGIN-SI (KR); TAKASHI HIBINO, NAGOYA (JP); YONG-CHENG JIN, TOKYO (JP)

(73) Assignee: SAMSUNG ELECTRONICS CO. LTD., SUWON-SI (KR)

(21) Appl. No.: 13/287,618

(22) Filed: Nov. 2, 2011

(30) Foreign Application Priority Data
Jul. 18, 2011 (KR) 10-2011-0071089

(51) Int. Cl. H01M 8/10

(52) U.S. Cl. 429/492

(57) ABSTRACT

A composite membrane containing a composite material including an azole-based polymer and a compound represented by Formula 3 below, a method of preparing the composite membrane, and a fuel cell including the composite membrane:

M¹₁₋ₐM²ₐPₓO_{y} <Formula 3>
wherein, in Formula 3, M¹ is a tetravalent metallic element; M² is at least one metal selected from the group consisting of a monovalent metallic element, a divalent metallic element, and a trivalent metallic element; a satisfies 0≦a<1; x is a number from 1.5 to 3.5; and y is a number from 5 to 13.

### CROSS-REFERENCE TO RELATED APPLICATION

This application claims the benefit of Korean Patent Application No. 10-2011-0071089, filed on Jul. 18, 2011 in the Korean Intellectual Property Office, the disclosure of which is incorporated herein by reference.

### BACKGROUND OF THE INVENTION

1. Field of the Invention

Aspects of the present invention relate to a composition, a composite membrane prepared therefrom, a method of preparing the composite membrane, and a fuel cell including the composite membrane.

2. Description of the Related Art

Fuel cells can be classified according to types of an electrolyte and fuel used as polymer electrolyte membrane fuel cells (PEMFCs), direct methanol fuel cells (DMFCs), phosphoric acid fuel cells (PAFCs), molten carbonate fuel cells (MCFCs), or solid oxide fuel cells (SOFCs).

PEMFCs operating at 100° C. or higher temperatures in non-humidified conditions as compared to those operable at low temperatures, do not need a humidifier, are known to be convenient in terms of control of water supply, and are highly reliable in terms of system operation. Furthermore, such PEMFCs may become more durable against carbon monoxide poisoning that may occur with fuel electrodes as they operate at high temperatures, and thus, a simplified reformer may be used therefor. These advantages mean that PEMFCs are increasingly drawing attention for use in such high-temperature, non-humidifying systems.

In addition to the current trends for increasing the operation temperature of PEMFCs as described above, fuel cells generally operable at high temperatures are drawing more attention. However, electrolyte membranes of fuel cells that have been developed so far do not exhibit satisfactory proton conductivities and mechanical strength at high temperatures, and thus, still require further improvement.

### SUMMARY OF THE INVENTION

Aspects of the present invention provide a composition, a composite membrane prepared from the composition and having high proton conductivity with a low doping level of phosphoric acid, a method of preparing the composite membrane, and a high-performance fuel cell including the composite membrane.

According to an aspect of the present invention, a composition includes a compound represented by Formula 1 below, a compound represented by Formula 2 below, and an azole-based polymer:

M¹A_{b} [Formula 1]

wherein in Formula 1, M¹ is a tetravalent metallic element; A is chloride (Cl), hydroxide (OH), oxide (O), nitride (N), sulfate, or phosphate; and b is a number from 1 to 5, and

M²_{c}A_{d} [Formula 2]

wherein in Formula 2, M² is at least one metal selected from the group consisting of a monovalent metallic element, a divalent metallic element, and a trivalent metallic element; A is chloride (Cl), hydroxide (OH), oxide (O), nitride (N), sulfate, or phosphate; c is a number from 1 to 2; and d is a number from 2 to 4.

According to another aspect of the present invention, a composite membrane includes a composite containing a compound represented by Formula 3 below and an azole-based polymer:

M¹₁₋ₐM²ₐPₓO_{y} [Formula 3]

wherein, in Formula 3, M¹ is a tetravalent metallic element; M² is at least one metal selected from the group consisting of a monovalent metallic element, a divalent metallic element, and a trivalent metallic element; a satisfies 0≦a<1; x is a number from 1.5 to 3.5; and y is a number from 5 to 13.

According to another aspect of the present invention, a method of preparing a composite membrane includes: supplying a phosphoric acid-based material to a first composite membrane including a compound represented by Formula 1 below, a compound represented by Formula 2 below, and an azole-based polymer; and thermally treating the first composite membrane to which the phosphoric acid-based material has been supplied to form the composite membrane including a composite containing a compound represented by Formula 3 below and an azole-based polymer:

M¹A_{b} [Formula 1]

wherein, in Formula 1, M¹ is a tetravalent metallic element; A is chloride (Cl), hydroxide (OH), oxide (O), nitride (N), sulfate, or phosphate; and b is a number from 1 to 5,

M²_{c}A_{d} [Formula 2]

wherein, in Formula 2, M² is at least one metal selected from the group consisting of a monovalent metallic element, a divalent metallic element, and a trivalent metallic element; A is chloride (Cl), hydroxide (OH), oxide (O), nitride (N), sulfate, or phosphate; c is a number from 1 to 2; and d is a number from 2 to 4, and

M¹₁₋ₐM²ₐPₓO_{y} [Formula 3]

wherein, in Formula 3, M¹ is a tetravalent metallic element; M² is at least one metal selected from the group consisting of a monovalent metallic element, a divalent metallic element, and a trivalent metallic element; a satisfies 0≦a<1; x is a number from 1.5 to 3.5; and y is a number from 5 to 13.

According to another aspect of the present invention, a fuel cell includes the above-described composite membrane.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a perspective exploded view of a fuel cell according to an embodiment of the present invention;

FIG. 2 is a cross-sectional diagram of a membrane-electrode assembly (MEA) of the fuel cell of FIG. 1;

FIGS. 3 to 5 are scanning electron microscopic (SEM) images of a first composite membrane, a composite membrane formed according to Example 1, and a product of Comparative Example 1, respectively;

FIG. 6 is an X-ray diffraction (XRD) spectrum of the composite membrane of Example 1;

FIG. 7 is a thermogravimetric-differential thermal analysis (TG-DTA) spectrum of the composite membrane of Example 1;

FIGS. 8 and 9 are SEM images of the composite membrane of Example 1, obtained using a SEM equipped with an energy dispersive X-ray detector;

FIG. 10 illustrates graphs of phosphoric acid doping level with respect to time of the composite membrane of Example 1 and the PBI membrane of Comparative Example 2;

FIG. 11 illustrates ³¹P-NMR spectra of the composite membrane of Example 1 and the phosphoric acid-doped PBI membrane of Comparative Example 2;

FIG. 12 illustrates ¹H-NMR spectra of the composite membrane of Example 1 and the phosphoric acid-doped PBI membrane of Comparative Example 2;

FIG. 13 is a graph of proton conductivities of the composite membrane of Example 1 and the phosphoric acid-doped PBI membrane of Comparative Example 2;

FIG. 14 is a graph of cell voltage and output density with respect to current density of the composite membrane of Example 1;

FIG. 15 is a graph of cell voltage and output density with respect to current density of the phosphoric acid-doped PBI membrane of Comparative Example 2; and

FIG. 16 illustrates graphs of cell voltage with respect to time of the composite membrane of Example 1 and the phosphoric acid-doped PBI membrane of Comparative Example 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An aspect of the present invention provides a composition including a compound represented by Formula 1 below, a compound represented by Formula 2, and an azole-based polymer.

M¹A_{b} [Formula 1]

wherein, in Formula 1, M¹ is a tetravalent metallic element; A is chloride (Cl), hydroxide (OH), oxide (O), nitride (N), sulfate, or phosphate; and b is a number from 1 to 5.

M²_{c}A_{d} [Formula 2]

wherein, in Formula 2, M² is at least one metal selected from the group consisting of a monovalent metallic element, a divalent metallic element, and a trivalent metallic element; A is chloride (Cl), hydroxide (OH), oxide (O), nitride (N), sulfate, or phosphate; c is a number from 1 to 2; and d is a number from 2 to 4.

The composition may be used to form a first composite membrane including the compound of Formula 1, the compound of Formula 2, and an azole-based polymer, and to form a composite membrane formed using the first composite membrane and containing a composite including a compound represented by Formula 3 below and an azole-based polymer.

M¹₁₋ₐM²ₐPₓO_{y} [Formula 3]

wherein, in Formula 3, M¹ is a tetravalent metallic element; M² is at least one metal selected from the group consisting of a monovalent metallic element, a divalent metallic element, and a trivalent metallic element; a satisfies 0≦a<1; x is a number from 1.5 to 3.5; and y is a number from 5 to 13.

The composite material may further include a phosphoric acid-based material. In the composite membrane with such a composition as described above, protons in the compound of Formula 3 are more interactive with the phosphoric acid-based material than those in the azole-based polymer do with a phosphoric acid-based material doping the azole-based polymer. Therefore, using the composite membrane as an electrolyte membrane, a fuel cell exhibiting high performance at high temperatures may be manufactured.

In Formula 1, b may be a number from 2 to 4.

The compound of Formula 1 may be a compound of Formula 1A below:

M¹O_{b} [Formula 1A]

wherein, in Formula 1A, M¹ is a tetravalent metallic element; and b is a number from 1 to 3.

In Formulae 1 and 1A above, M¹ is a metallic element capable of forming tetravalent cations. For example, M¹ may be at least one metal selected from the group consisting of tin (Sn), zirconium (Zr), tungsten (W), silicon (Si), molybdenum (Mo), and titanium (Ti). Further for example, in Formulae 2 or 3, M² may be at least one metal selected from the group consisting of lithium (Li), sodium (Na), potassium (K), cesium (Cs), beryllium (Be), magnesium (Mg), calcium (Ca), strontium (Sr), barium (Ba), indium (In), aluminum (Al), and antimony (Sb).

The compound of Formula 1 may be at least one compound selected from among tin oxide (SnO₂), tin chlorides (SnCl₄ and SnCl₂), tin hydroxide (Sn(OH)₄), tin (IV) hydrogen phosphate (Sn(HPO₄)₂), tungsten oxide (WO₂), tungsten chloride (WCl₄), molybdenum oxide (MoO₂), molybdenum chloride (MoCl₃), zirconium oxide (ZrO2), zirconium chloride (ZrCl₄), zirconium hydroxide (Zr(OH)₄), titanium oxide (TiO₂), titanium sulfate (Ti(SO₄)₂), and titanium chlorides (TiCl₂ and TiCl₃).

In the composition the amount of the azole-based polymer may be from about 100 parts to about 170 parts by weight based on 100 parts by weight of the compound of Formula 1.

The amount of the compound of Formula 1 may be from about 2 moles to about 99 moles based on 1 mole of the compound of Formula 2.

The amount of the azole-based polymer may be from about 50 parts to about 120 parts by weight, and in some embodiments, may be from about 70 parts by weight to about 100 parts by weight based on 100 parts by weight of a total weight of the compound of Formula 1 and the compound of Formula 2.

The composition may further include a phosphoric acid-based material.

The amount of the phosphoric acid-based material may be from about 270 parts to about 500 parts by weight based on 100 parts by weight of the compound of Formula 1. When the amount of the phosphoric acid-based material is within this range, a composite membrane manufactured from the composition may have high proton conductivity even with a small doping amount of the phosphoric acid-based material.

When the amount of the azole-based polymer is within this range, a composite membrane manufactured from the composition may have high thermal stability and proton conductivity without a decrease in mechanical stability.

The amounts of the compound of Formula 1 and the compound of Formula 2 may be adjusted to be within a stoichiometric ratio for forming the compound of Formula 3. In some embodiments, the amount of the compound of Formula 1 may be from about 1 mole to about 25 moles based on 1 mole of the compound of Formula 2.

The compound of Formula 2 may be a compound of Formula 2A below:

M²_{c}(OH)_{d} [Formula 2A]

wherein, in Formula 2A, M2 is at least one metal selected from the group consisting of a monovalent metallic element, a divalent metallic element, and a trivalent metallic element; c is 1; and d is a number from 2 to 4.

The compound of Formula 2 may be at least one compound selected from among aluminum hydroxide, aluminum chloride, aluminum sulfate, aluminum oxide, aluminum nitride, indium hydroxide, indium chloride, antimony hydroxide, antimony chloride, lithium hydroxide, lithium oxide, lithium chloride, lithium nitrate, sodium hydroxide, sodium chloride, potassium hydroxide, potassium chloride, cesium hydroxide, cesium chloride, beryllium chloride, magnesium hydroxide, magnesium oxide, calcium hydroxide, calcium chloride, strontium hydroxide, strontium chloride, barium hydroxide, and barium chloride.

The azole-based polymer indicates a polymer, a repeating unit of which includes at least one aryl ring having at least one nitrogen atom. The aryl ring may be a five-membered or six-membered ring with one to three nitrogen atoms where the ring may be fused to another ring, for example, another aryl ring or heteroaryl ring. Further, the nitrogen atoms may be substituted with or bonded to oxygen, phosphorus and/or sulfur atoms. Examples of the aryl ring include phenyl, naphthyl, hexahydroindyl, indanyl, tetrahydronaphthyl, and the like.

The azole-based polymer may have at least one amino group in the repeating unit as described above. In this regard, the at least one amino group may be a primary, secondary or tertiary amino group which are either part of the aryl ring or part of a substituent of the aryl unit.

The term “amino group” indicates a group with a nitrogen atom covalently bonded to at least one carbon or hetero atom. The amino group may refer to, for example, —NH2 and substituted moieties.

The term “alkylamino group” may also refer to an “alkylamino group” with a nitrogen atom bound to at least one additional alkyl group. The term “arylamino group” and “diarylamino” may also refer to at least one or two nitrogen atoms bound to a selected aryl group.

Methods of preparing an azole-based polymer and a polymer film including an azole-based polymer are disclosed in US 2005/256296A.

Examples of the azole-based polymer include azole units represented by Formulae 4 to 17.

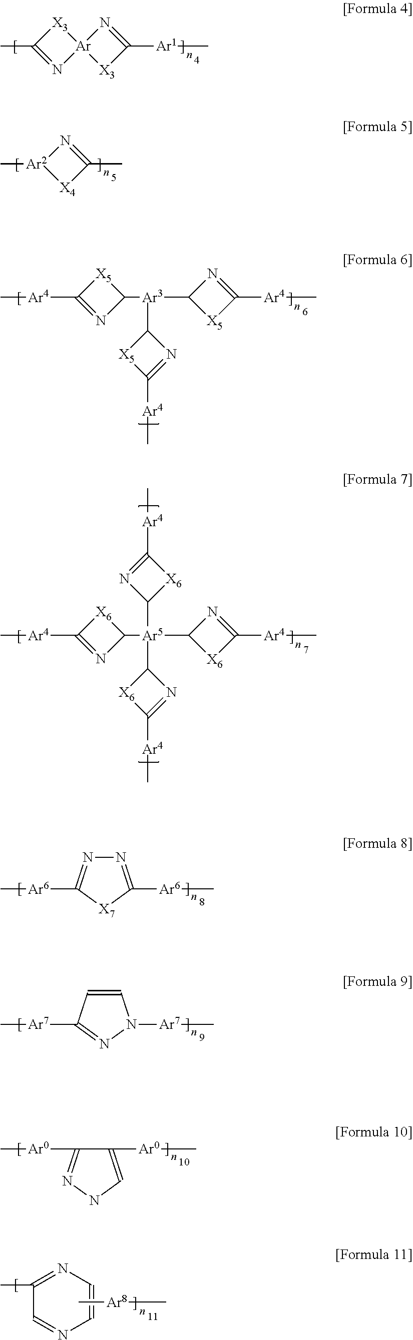

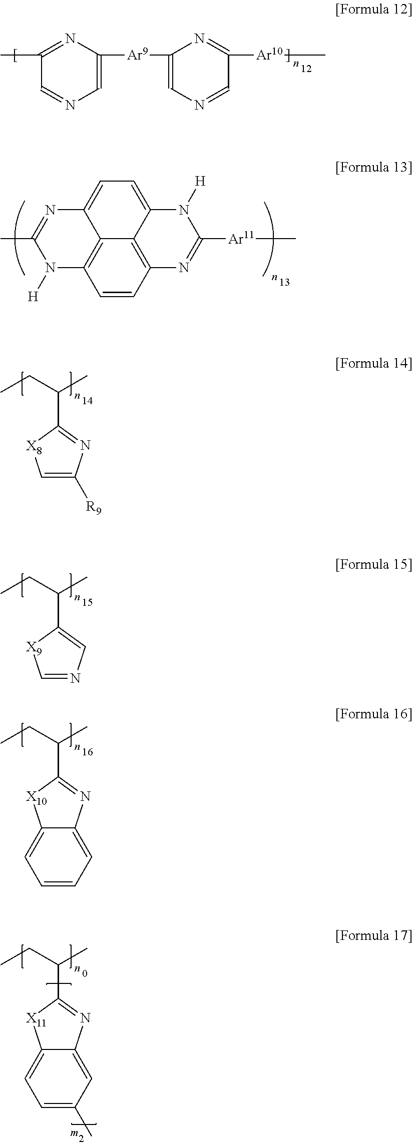

In Formulae 21 to 34, Ar⁰ may be identical to or different from another A⁰, or any other Arⁿ (where n can be no superscript or 1 to 11), and may be a bivalent monocyclic or polycyclic C6-C20 aryl group or a C2-C20 heteroaryl group;

Ar may be identical to or different from another A, or any other Arⁿ (where n can be no superscript or 0 to 11), and may be a tetravalent monocyclic or polycyclic C6-C20 aryl group or a C2-C20 heteroaryl group;

Ar¹ may be identical to or different from another A¹, or any other Arⁿ (where n can be no superscript or 0 to 11), and may be a bivalent monocyclic or polycyclic C6-C20 aryl group or a C2-C20 heteroaryl group;

Ar² may be identical to or different from another A², or any other Arⁿ (where n can be no superscript or 0 to 11), and may be a bivalent or trivalent monocyclic or polycyclic C6-C20 aryl group or a C2-C20 heteroaryl group;

Ar³ may be identical to or different from another A³, or any other Arⁿ (where n can be no superscript or 0 to 11), and may be a trivalent monocyclic or polycyclic C6-C20 aryl group or a C2-C20 heteroaryl group;

Ar⁴ may be identical to or different from another A⁴, or any other Arⁿ (where n can be no superscript or 0 to 11), and may be a trivalent monocyclic or polycyclic C6-C20 aryl group or a C2-C20 heteroaryl group;

Ar⁵ may be identical to or different from another A⁵, or any other Arⁿ (where n can be no superscript or 0 to 11), and may be a tetravalent monocyclic or polycyclic C6-C20 aryl group or a C2-C20 heteroaryl group;

Ar⁶ may be identical to or different from another A⁶, or any other Arⁿ (where n can be no superscript or 0 to 11), and may be a bivalent monocyclic or polycyclic C6-C20 aryl group or a C2-C20 heteroaryl group;

Ar⁷ may be identical to or different from another A⁷, or any other Arⁿ (where n can be no superscript or 0 to 11), and may be a bivalent monocyclic or polycyclic C6-C20 aryl group or a C2-C20 heteroaryl group;

Ar⁸ may be identical to or different from another A⁸, or any other Arⁿ (where n can be no superscript or 0 to 11), and may be a trivalent monocyclic or polycyclic C6-C20 aryl group or a C2-C20 heteroaryl group;

Ar⁹ may be identical to or different from another A⁹, or any other Arm (where n can be no superscript or 0 to 11), and may be a bivalent, trivalent or tetravalent monocyclic or polycyclic C6-C20 aryl group or a C2-C20 heteroaryl group;

Ar¹⁰ may be identical to or different from another A¹⁰, or any other Arⁿ (where n can be no superscript or 0 to 11), and may be a bivalent or trivalent monocyclic or polycyclic C6-C20 aryl group or a C2-C20 heteroaryl group;

Ar¹¹ may be identical to or different from another A¹¹, or any other Arⁿ (where n can be no superscript or 0 to 11), and may be a bivalent monocyclic or polycyclic C6-C20 aryl group or a C2-C20 heteroaryl group;

X₃ to X₁₁ may each be identical to or different from another X₃ to X₁₁, and may be an oxygen atom, a sulfur atom or —N(R′); and R′ may be a hydrogen atom, a C1-C20 alkyl group, a C1-C20 alkoxy group or a C6-C20 aryl group;

R₉ may be identical to or different from another R₉, and may be a hydrogen atom, a C1-C20 alkyl group or a C6-C20 aryl group; and

n₀, n₄ to n₁₆, and m₂ may each be independently an integer of 10 or greater, and in some embodiments, may each be an integer of 100 or greater, and in some other embodiments, may each be an integer of 100 to 100,000.

Examples of the aryl or heteroaryl group include benzene, naphthalene, biphenyl, diphenylether, diphenylmethane, diphenyldimethylmethane, bisphenone, diphenylsulfone, quinoline, pyridine, 2,2-bipyridine, 2,3-bipyridine, 2,4-bipyridine, 4,4-bipyridine, pyridazine, pyrimidine, pyrazine, triazine, tetrazine, pyrrole, pyrazole, anthracene, benzopyrrole, benzotriazole, benzoxathiazole, benzoxadiazole, benzopyridine, benzopyrazine, benzopyrazidine, benzopyrimidine, 1,2,4-benzotriazine, indolizine, quinolizine, pyridopyridine, imidazopyrimidine, pyrazinopyrimidine, carbazole, aziridine, phenazine, 2,3-benzoquinoline, 3,4-benzoquinoline, 5,6-benzoquinoline, 7,8-benzoquinoline, phenoxazine, phenothiazine, benzopteridine, 1,7-phenanthroline, 1,10-phenanthroline, and phenanthrene, wherein these aryl or heteroaryl groups may have a substituent.

Ar¹, Ar⁴, Ar⁶, Ar⁷, Ar⁸, Ar⁹, Ar¹⁰, and Ar¹¹ defined above may have any substitutable pattern. For example, if Ar¹, Ar⁴, Ar⁶, Ar⁷, Ar⁸, Ar⁹, Ar¹⁰, and Ar¹¹ are phenylene, Ar¹, Ar⁴, Ar⁶, Ar⁷, Ar⁸, Ar⁹, Ar¹⁰, or Ar¹¹ may be ortho-phenylene, meta-phenylene or para-phenylene.

The alkyl group may be a C1-C4 short-chain alkyl group, such as methyl, ethyl, n-propyl, i-propyl or t-butyl. The aryl group may be, for example, a phenyl group or a naphthyl group.

Examples of the substituent include a halogen atom, such as fluorine, an amino group, a hydroxyl group, and a short-chain alkyl group, such as methyl or ethyl.

Examples of the azole-based polymer include polyimidazole, polybenzothiazole, polybenzoxazole, polyoxadiazole, polyquinoxaline, polythiadiazole, polypyridine, polypyrimidine, and polytetrazapyrene.

The azole-based polymer may be a copolymer or blend including at least two units selected from among units represented by Formulae 4 to 17 above. The azole-based polymer may be a block copolymer (di-block or tri-block), a random copolymer, a periodic copolymer or an alternating polymer including at least two units selected from the units of polymers represented by Formulae 21 to 34.

In some embodiments, the azole-based polymer may include only at least one of the units of polymers represented by Formulae 4 and 5.

Examples of the azole-based polymer include polymers represented by Formulae 18 to 44 below:

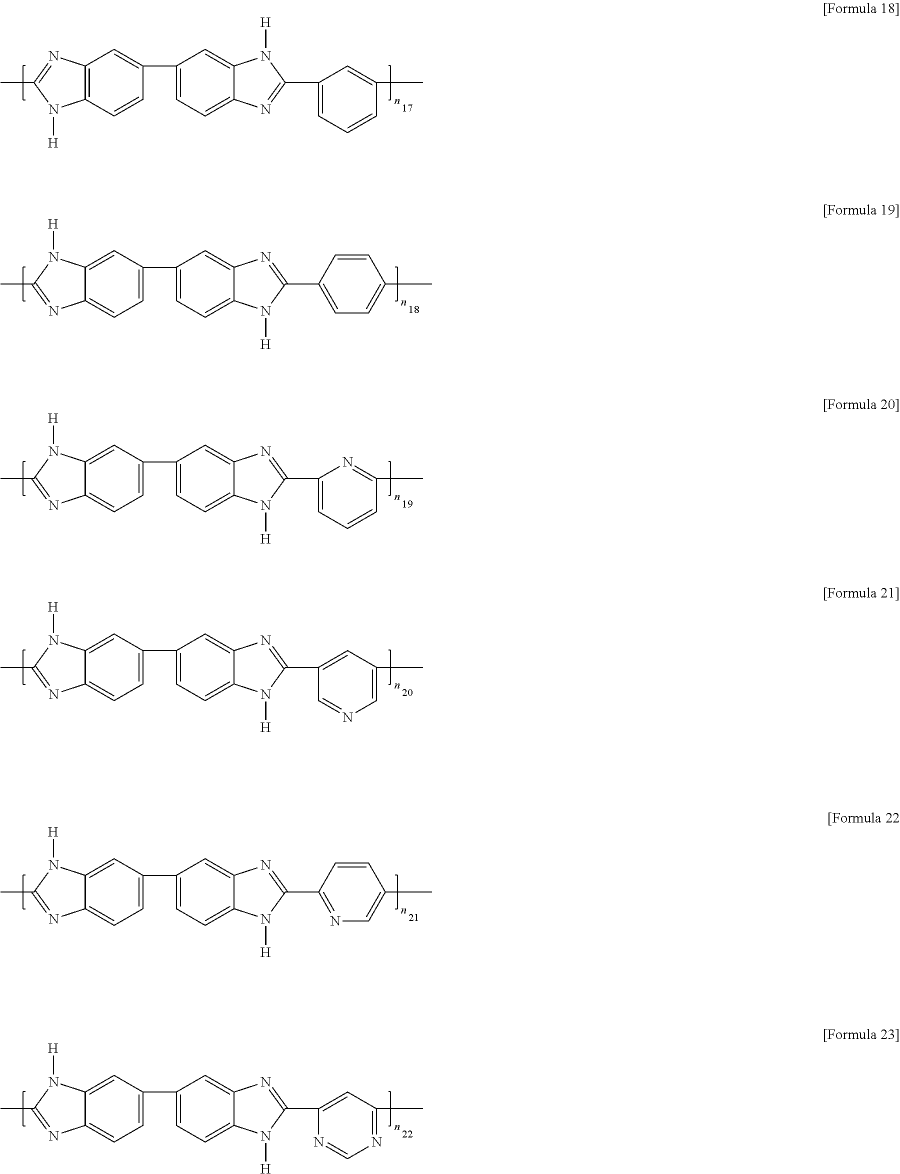

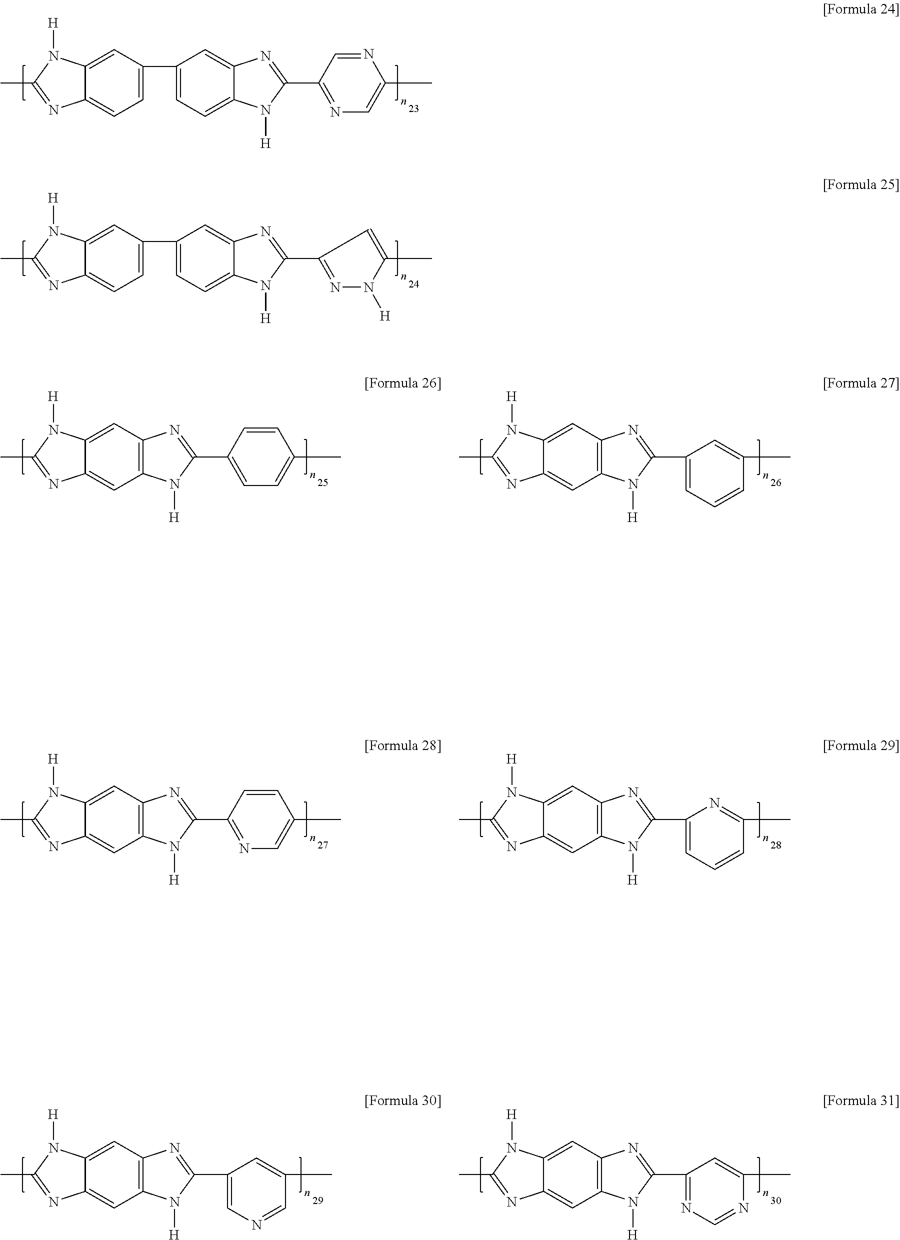

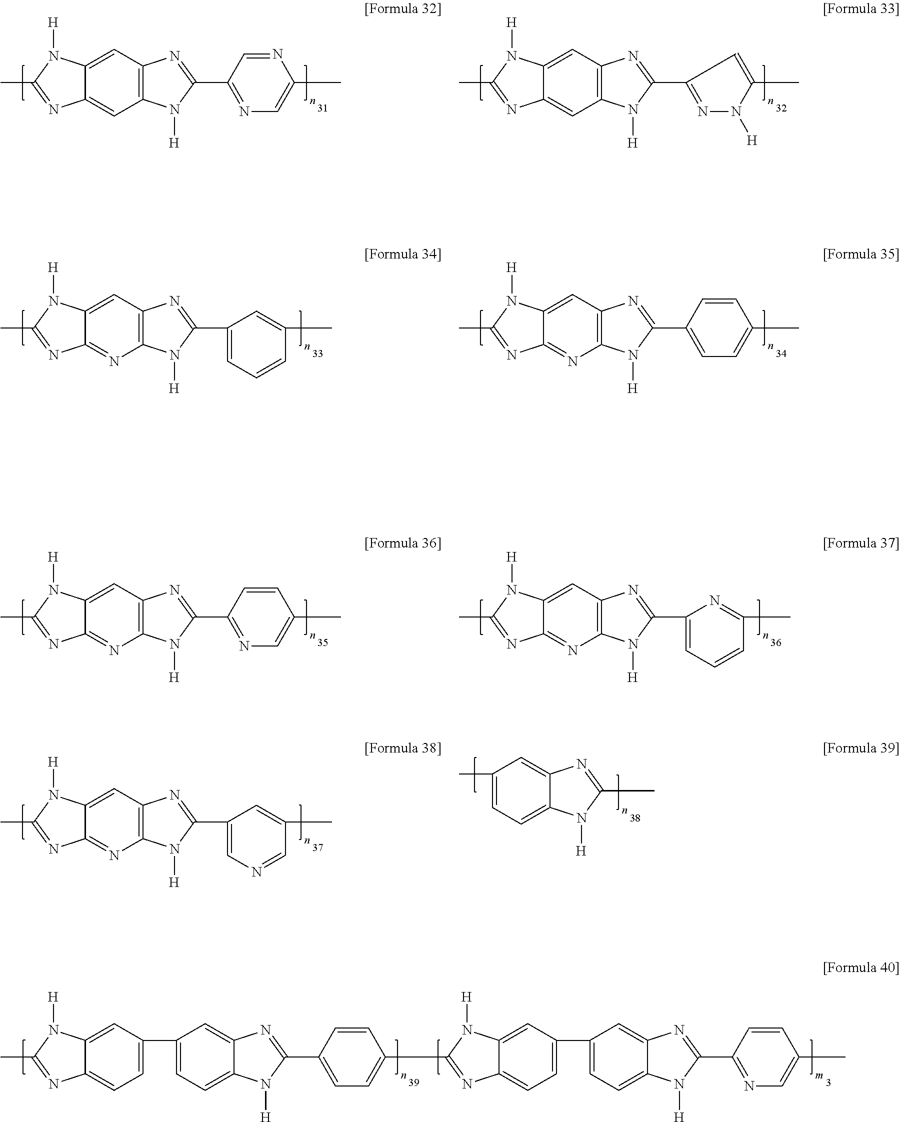

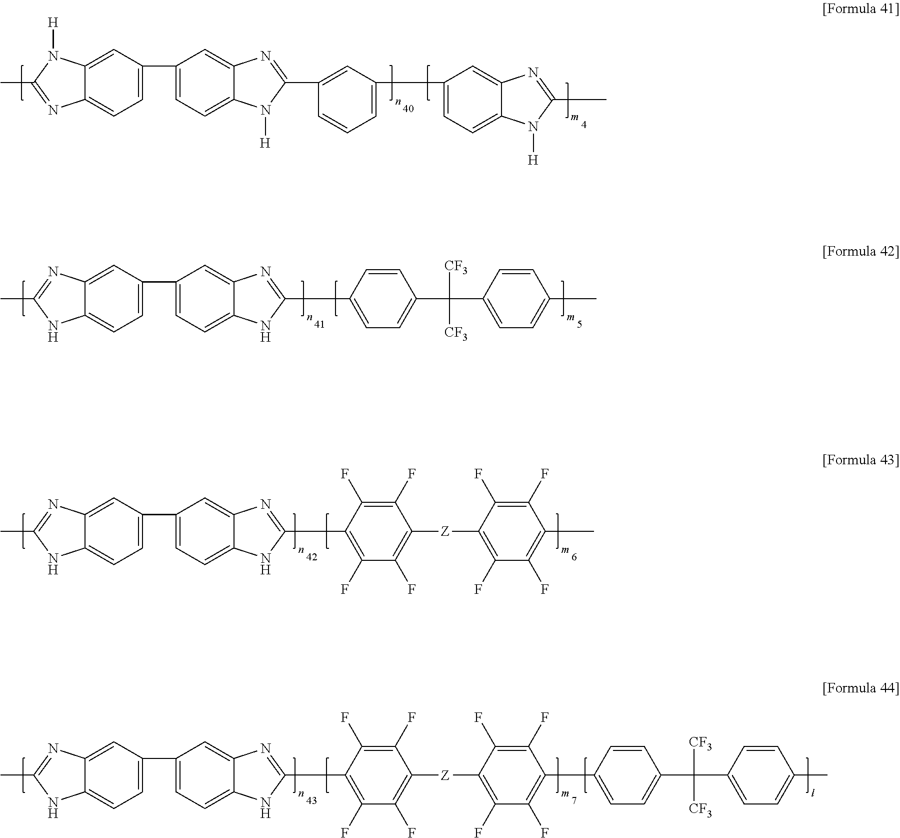

In Formulae 18 to 44, I, n₁₇ to n₄₃, and m₃ to m₇ may each be an integer of 10 or greater, and in some embodiments, may be an integer of 100 or greater; and z may be a chemical bond, —(CH₂)ₛ—, —C(═O)—, —SO₂—, —C(CH₃)₂—, or —C(CF₃)₂; and s may be an integer from 1 to 5.

The azole-based polymer may be a compound including m-polybenzimidazole (PBI) represented by Formula 45 below, or a compound including p-PBI represented by Formula 46 below.

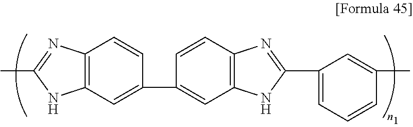

wherein, in Formula 45, n₁ is an integer of 10 or greater.

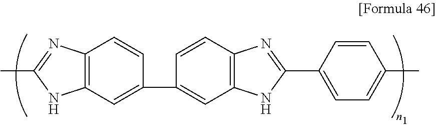

wherein, in Formula 46, n₁ is an integer of 10 or greater.

The polymers of Formulae 45 and 46 may each have a number average molecular weight of 1,000,000 or less.

For example, the azole-based polymer may be a benzimidazole-based polymer represented by Formula 47 below.

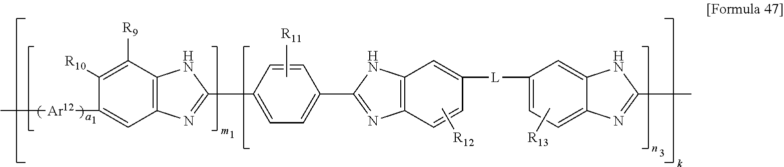

wherein, in Formula 47, R₉ and R₁₀ are each independently a hydrogen atom, an unsubstituted or substituted C1-C20 alkyl group, an unsubstituted or substituted C1-C20 alkoxy group, an unsubstituted or substituted C6-C20 aryl group, an unsubstituted or substituted C6-C20 aryloxy group, an unsubstituted or substituted C3-C20 heteroaryl group, or an unsubstituted or substituted C3-C20 heteroaryloxy group;

R₉ and R₁₀ may be linked to form a C4-C20 carbon ring or a C3-C20 hetero ring,

Ar₁₂ is a substituted or unsubstituted C6-C20 arylene group or a substituted or unsubstituted C3-C20 heteroarylene group,

R₁₁ to R₁₃ are each independently a single or a multi-substituted substituent selected from the group consisting of a hydrogen atom, a substituted or unsubstituted C1-C20 alkyl group, a substituted or unsubstituted C1-C20 alkoxy group, a substituted or unsubstituted C6-C20 aryl group, a substituted or unsubstituted C6-C20 aryloxy group, a substituted or unsubstituted C6-C20 heteroaryl group, and a substituted or unsubstituted C3-C20 heteroaryloxy group,

L represents a linker,

m₁ is from 0.01 to 1,

a₁ is 0 or 1,

n₃ is a number from 0 to 0.99, and

k is a number from 10 to 250.

The benzimidazole-based polymer may be a compound represented by Formula 48 below or a compound represented by Formula 49 below:

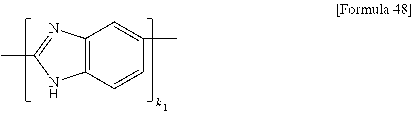

In Formula 48, k₁ represents degree of polymerization and is a number from 10 to 300.

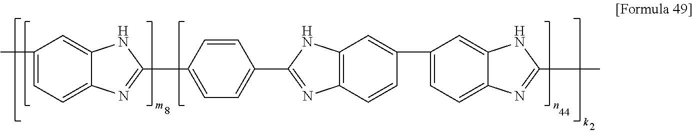

In Formula 49, m₈ is a number from 0.01 to 1, and in some embodiments, may be a number from 0.1 to 0.9; and n₄₄ is a number from 0 to 0.99, and in some embodiments, may be 0 or a number from 0.1 to 0.9; and k₂ is a number from 10 to 250.

Another aspect of the present invention provides a composite membrane including a compound of Formula 1 above, a compound of Formula 2 above, and an azole-based polymer. The amounts and types of the compound of Formula 1, the compound of Formula 2, and the azole-based polymer may be the same as those described above in conjunction with the composition.

In an embodiment, the composite membrane may include, for example, SnO₂, Al(OH)₃, and an azole-based polymer.

The azole-based polymer may be 2,5-polybenzimidazole, poly(2,2′-(m-phenylene)-5,5′-bibenzimidazole) (m-PBI), or poly(2,2′-(p-phenylene)-5,5′-bibenzimidazole) (p-PBI).

According to another embodiment, the composite membrane may include a composite material containing a compound represented by Formula 3 and an azole-based polymer.

M¹₁₋ₐM²ₐPₓO_{y} [Formula 3]

wherein, in Formula 3, M¹ is a tetravalent metallic element; M² is at least one metal selected from the group consisting of a monovalent metallic element, a divalent metallic element, and a trivalent metallic element; a satisfies 0≦a<1; x is a number from 1.5 to 3.5; and y is a number from 5 to 13.

In Formula 3 above, M¹ is a metallic element capable of forming tetravalent cations. For example, M¹ may be at least one metal selected from the group consisting of tin (Sn), zirconium (Zr), tungsten (W), silicon (Si), molybdenum (Mo), and titanium (Ti).

For another example, M² may be at least one metal selected from the group consisting of lithium (Li), sodium (Na), potassium (K), cesium (Cs), beryllium (Be), magnesium (Mg), calcium (Ca), strontium (Sr), barium (Ba), indium (In), aluminum (Al), and antimony (Sb).

In Formula 3 above, if a is greater than 0, the M¹ capable of forming tetravalent cations may be partially substituted with an M² that is a monovalent, divalent or trivalent metal.

In Formula 3, a may be a number from about 0.01 to about 0.7.

In Formula 3, a may be a number from 0.05 to 0.5, and in some embodiments, may be a number from 0.1 to 0.4.

In Formula 3, x may be 2, and y may be 7.

In Formula 3, M¹ may be tin (Sn), and M² may be indium (In). In an embodiment the compound of Formula 3 may be Sn₁₋ₐAlₐP₂O₇ where a is from 0.05 to 0.5.

More specifically, the compound of Formula 3 may be selected from among Sn_{0.9}In_{0.1}P₂O₇, Sn_{0.95}Al_{0.05}P₂O₇, Ti_{0.9}In_{0.1}P₂O₇, Ti_{0.95}Al_{0.05}P₂O₇, Zr_{0.9}In_{0.1}P₂O₇, Zr_{0.95}Al_{0.05}P₂O₇, W_{0.9}In_{0.1}P₂O₇, W_{0.95}Al_{0.05}P₂O₇, Sn_{0.7}Li_{0.3}P₂O₇, Sn_{0.95}Li_{0.05}P₂O₇, Sn_{0.9}Li_{0.1}P₂O₇, Sn_{0.8}Li_{0.2}P₂O₇, Sn_{0.6}Li_{0.4}P₂O₇, Sn_{0.5}Li_{0.5}P₂O₇, Sn_{0.7}Na_{0.3}P₂O₇, Sn_{0.7}K_{0.3}P₂O₇, Sn_{0.7}Cs_{0.3}P₂O₇, Zr_{0.9}Li_{0.1}P₂O₇, Ti_{0.9}Li_{0.1}P₂O₇, Si_{0.9}Li_{0.1}P₂O₇, Mo_{0.9}Li_{0.1}P₂O₇, W_{0.9}Li_{0.1}P₂O₇, Sn_{0.7}Mg_{0.3}P₂O₇, Sn_{0.95}Mg_{0.05}P₂O₇, Sn_{0.9}Mg_{0.1}P₂O₇, Sn_{0.8}Mg_{0.2}P₂O₇, Sn_{0.6}Mg_{0.4}P₂O₇, Sn_{0.5}Mg_{0.5}P₂O₇, Sn_{0.7}Ca_{0.3}P₂O₇, Sn_{0.7}Sr_{0.3}P₂O₇, Sn_{0.7}Ba_{0.3}P₂O₇, Zr_{0.9}Mg_{0.1}P₂O₇, Ti_{0.9}Mg_{0.1}P₂O₇, Si_{0.9}Mg_{0.1}P₂O₇, Mg_{0.9}Mg_{0.1}P₂O₇, W_{0.9}Mg_{0.1}P₂O₇, Zr_{0.7}Mg_{0.3}P₂O₇, Ti_{0.7}Mg_{0.3}P₂O₇, Si_{0.7}Mg_{0.3}P₂O₇, Mg_{0.7}Mg_{0.3}P₂O₇, and W_{0.7}Mg_{0.3}P₂O₇.

The compound of Formula 3 may be a tin phosphate compound where M¹ is tin (Sn). Due to having a dense structure, a tin phosphate compound is suitable for forming a proton path.

The tin phosphate compound may be a compound of Formula 3 where M¹ for Sn is partially substituted with trivalent indium (In) or aluminum (Al) ions. In the compound with M¹ for Sn that is partially substituted with trivalent ions, the substitution may be readily obtained due to a similar diameter of the trivalent ions with the ionic diameter of tetravalent Sn, and defects from the substitution may help dissolution of protons. Therefore, using such a compound, a composite membrane having high proton conductivity even at a low doping level of phosphoric acid may be manufactured.

The composite membrane may further include a phosphoric acid-based material.

Examples of the phosphoric acid-based material include phosphoric acid, polyphosphoric acid, phosphonic acid (H₃PO₃), ortho-phosphoric acid (H₃PO₄), pyro-phosphoric acid (H₄P₂O₇), triphosphoric acid (H₅P₃O₁₀), meta-phosphoric acid, and a derivative thereof. In an embodiment, the phosphoric acid-based material may be phosphoric acid.

The concentration of the phosphoric acid-based material may be from about 80 wt % to about 100 wt %, and in some embodiments, may be about 85 wt %. When an 85 wt % aqueous phosphoric acid solution is used as the phosphoric acid-based material, the amount of the phosphoric acid-based material may be from about 270 parts to about 500 parts by weight based on 100 parts by weight of the compound of Formula 1. When the amount of the phosphoric acid-based material is within this range, the composite membrane may have high proton conductivity.

The doping level of the phosphoric acid-based material in the composite membrane described above may be from about 100% to about 300%, and in another embodiment, may be about 114%. The doping level of the phosphoric acid-based material is defined by Equation 1 below.

Doping level of phosphoric acid-based material (%)=(W−Wₚ)/Wₚ×100 [Equation 1]

In Equation 1, W and Wₚ indicate the weights of the composite membrane after and before doping with the phosphoric acid-based material, respectively.

The composite membrane contains a composite of an azole-based polymer doped with a phosphoric acid-based material and the compound of Formula 3, and may have improved proton conductivity and long-term durability due to interaction of protons in the compound of Formula 3 with the phosphoric acid-based material, as compared with the case when only the azole-based material is doped with the phosphoric acid-based material.

The above-described structural characteristics of the composite forming the composite membrane are supported by spectroscopic analysis data described below. The peak intensity of the composite by ³¹P nuclear magnetic resonance (NMR) spectroscopy at 0 ppm is weaker than that of only the azole-based polymer doped with a phosphoric acid-based material (for example, phosphoric acid) at 0 ppm. The azole-based polymer may be m-PBI. This indicates that the phosphoric acid doping level of the composite membrane is less than that of a phosphoric acid-doped azole-based polymer membrane.

The composite exhibits two distinct resonance peaks by ¹H NMR at 9.0±0.2 ppm and 8.2±0.2 ppm, respectively. In some embodiments, the composite may have a first peak at about 9.1 ppm and a second peak at about 8.3 ppm. The second peak at 8.3 ppm is attributed to protons incorporated into the compound of Formula 3.

The particle diameter of the compound of Formula 3 in the composite material may be calculated using Scherrer's equation from a peak width at a half amplitude on the (200) plane in an X-ray diffraction spectrum. According to the X-ray diffraction spectrum, a plane interval (d₂₀₀) of the plane (200) in the X-ray diffraction spectrum may be from about 3.36 nm to about 3.37 nm, and the particle diameter of the compound of Formula 3 determined from the peak width at a half amplitude on the (200) plane may be from about 10 nm to about 100 nm, and in some embodiments, may be from 5 nm to about 50 nm, or for example, may be 18 nm. As used herein, the particle diameter refers to the diameter of primary particles.

The composite material may exhibit a first endothermic peak at a temperature of about 50° C. to about 150° C., and a second endothermic peak at a temperature of about 150° C. to about 250° C., by TG-DTA (thermogravimetric-differential thermal analysis). The first endothermic peak is attributed to the desorption of absorbed or adsorbed water, and the second endothermic peak is attributed to a dehydration reaction of the remaining H₃PO₄ in the composite membrane.

The azole-based polymer in the composite membrane hardly decomposes at a temperature as high as about 500° C. due to the presence of the compound of Formula 3, indicating that thermal stability of the composite membrane is excellent.

For the composite membrane, its main peak having a Bragg angle of 2θ for a CuK-α X-ray wavelength of 1.541 nm may range broadly from about 15 degrees to about 40 degrees. The main peak of the composite membrane having the highest intensity may range from about 20° to about 24°, and in another embodiment, may appear at about 22°. A subordinate peak of the composite membrane may range from about 24° to about 39°, and may appear at about 37 °.

Hereinafter, a method of preparing a first composite membrane including a compound of Formula 1 above, a compound of Formula 2 above, and an azole-based polymer now will be described. The compound of Formula 1, the compound of Formula 2, and the azole-based compound may be mixed to obtain a composition.

The composition may be coated and dried to form the first composite membrane, which includes the compound of Formula 1, the compound of Formula 2, and the azole-based polymer. The coating of the composition is not limited to a specific method, and may be performed by dipping, spray coating, screen printing, coating using gravure coating, dip coating, roll coating, comma coating, silk screen, or a combination of these methods. In an embodiment, the coating of the composition may be performed by applying the composition to a substrate, storing the substrate at a predetermined temperature to allow the composition to uniformly spread over the substrate, and shaping the composition into a membrane having a predetermined shaped using a doctor blade.

The mixing of the compound of Formula 1, the compound of Formula 2, and the compound of Formula 2, and the azole-based polymer is not limited in terms of the order of adding each component, or which solvent is used. In an embodiment, the compound of Formula 1 and the compound of Formula 2 may be mixed by grinding to obtain a mixed powder, which may then be mixed with the azole-based polymer and a solvent at the same time.

In another embodiment, the compound of Formula 1 and the compound of Formula 2 may be mixed by grinding to obtain a mixed powder, which may then be mixed with a solution of the azole-based polymer. The mixing process will now be described in more detail below.

First, the compound of Formula 1 and the compound of Formula 2 are mixed with a first solvent to obtain a mixture, which is then dried to remove the first solvent, thereby preparing a mixed powder of the compound of Formula 1 and the compound of Formula 2. During the mixing, a ball mill, for example, a planetary ball mill, may be used to mix the components while grinding.

The drying may be performed using a known method in the art. The drying may be performed at room or high temperatures, or in vacuum. In some embodiments, the drying may be performed at a temperature of about 30° C. to about 80° C.

Non-limiting examples of the first solvent include tetrahydrofuran, N-methylpyrrolidone, and N,N′-dimethylacetamide. The amount of the first solvent may be from about 100 parts by weight to about 1000 parts by weight based on 100 parts by weight of the total weight of the compound of Formula 1 and the compound of Formula 2. When the amount of the first solvent is within this range, the compound of Formula 1 and the compound of Formula 2 may be uniformly dispersed or mixed in powder form.

The mixed powder of the compound of Formula 1 and the compound of Formula 2 is mixed with an azole-based polymer to prepare a composition. In this mixing process, the mixed powder and the azole-based polymer may be mixed with a second solvent at the same time. In another embodiment, an azole-based polymer solution in which the azole-based polymer is dissolved in the second solvent may be used.

Non-limiting examples of the second solvent include N,N′-dimethylacetamide (DMAc), and N-methylpyrrolidone (NMP). The amount of the second solvent may be from about 100 parts to about 1000 parts by weight based on 100 parts by weight of the azole-based polymer.

The coating of the composition is not limited to a specific method, and may be performed by dipping, spray coating, screen printing, coating using gravure coating, dip coating, roll coating, comma coating, silk screen, or a combination of these methods. In an embodiment, the composition may be coated on a substrate and dried to form a film, which is then separated from the substrate, thereby obtaining a composite membrane.

The drying may be performed at a temperature of about 80° C. to about 150° C. When the drying is performed within this temperature range, a composite membrane with high proton conductivity may be obtained having a uniform thickness without significant degradation in mechanical stability.

The substrate is not specifically limited. For example, the substrate may be any of a variety of supports, such as a glass substrate, a release film, or an anode electrode. Non-limiting examples of the release film include a polytetrafluoroethylene film, a polyvinylidenefluoride film, a polyethyleneterepthalate film, and a biaxially-oriented polyethylene terephthalate film (BoPET)(for example, MYLAR® film, a trademark of the DuPont Corp).

The composite membrane may further include a phosphoric acid-based material.

Hereinafter, a method of preparing a composite membrane including a composite material containing the compound of Formula 3 above and an azole-based polymer now will be described.

A phosphoric acid-based material is applied to the first composite membrane formed as described above, which includes the compound of Formula 1, the compound of Formula 2, and the azole-based polymer. While the phosphoric acid-based material is applied, the reaction temperature may be from about 30° C. to about 120° C., and in another embodiment, may be at about 60° C.

The phosphoric acid-based material may be applied to the first composite membrane in any of a variety of manners. For example, the first composite membrane may be immersed in a phosphoric acid-based material.

Subsequently, as the first composite membrane provided with the phosphoric acid-based material is thermally treated, the composite membrane including a composite material containing the compound of Formula 3 and the azole-based polymer may be obtained.

For example, when the compound of Formula 1 is tin oxide, and the compound of Formula 2 is aluminum hydroxide, as a result of a reaction as in Reaction Scheme 1, Sn₁₋ₐAlₐP₂O₇ may be obtained as a compound of Formula 3:

(1−a)SnO₂+aAl(OH)₃+2H₃PO₄→Sn₁₋ₐAlₐP₂O₇+H₂O, and 0≦a<1. Reaction Scheme 1

In the composition membrane a weight ratio of the compound of Formula 3 to the azole-based polymer may be from about 1:99 to about 99:1, and in another embodiment, may be about 60:40.

The thermal treatment may be performed at a temperature of about 150° C. to 280° C., and in another embodiment, may be performed at about 250° C. The thermal treatment may be performed in a reducing gas atmosphere. The reducing gas atmosphere may include a mixed gas of hydrogen gas and an inert gas. The thermal treatment time varies depending on the thermal treatment temperature. In some embodiments, the thermal treatment time may be from about 1 hour to about 5 hours. The amount of the hydrogen gas may be from about 10% to about 20% by volume, and the amount of the inert gas may be from about 80% to about 90% by volume. Non-limiting examples of the insert gas include argon, helium, and nitrogen.

Prior to the thermal treatment, the surface of the first composite membrane doped with the phosphoric acid-based material may be wiped using, for example, ethanol, to remove the phosphoric acid-based material remaining on the first composite membrane.

The phosphoric acid-based material may serve both as a phosphorus (P) source and an acid source for the compound of Formula 3.

The composite membrane prepared through the above-described processes may have a thickness of about 1 μm to about 100 μm, and in some embodiments, may have a thickness of about 30 μm to about 50 μm. The composite membrane may be formed as a thin film having a thickness as defined above.

The composite membrane may be used as a non-humidified proton conductor, and may be use in a fuel cell operating in high-temperature, non-humidified conditions. The term “high temperature” refers to a temperature of about 150° C. to about 400° C.; however, the high temperature is not particularly limited.

An aspect of the present invention provides a fuel cell that includes the above-described composite membrane as an electrolyte membrane disposed between a cathode and an anode. The fuel cell may have high efficiency characteristics because it exhibits high proton conductivity and long lifetime characteristics at high temperatures in non-humidified conditions.

The fuel cell may be used for any purpose. For example, the fuel cell may be used to implement a solid oxide fuel cell (SOFC), a proton exchange membrane fuel cell (PEMFCs), and the like.

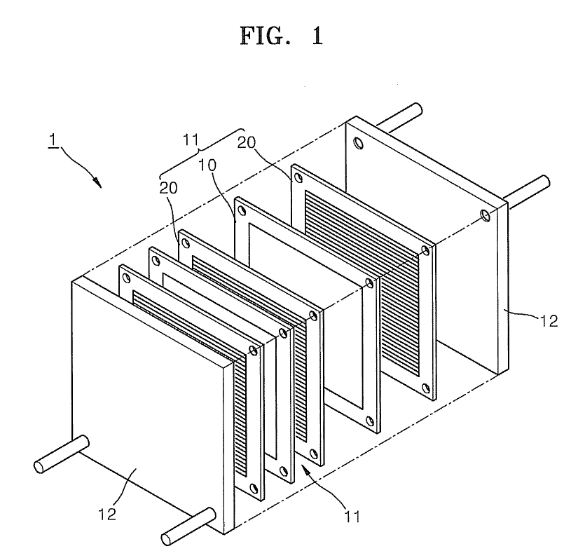

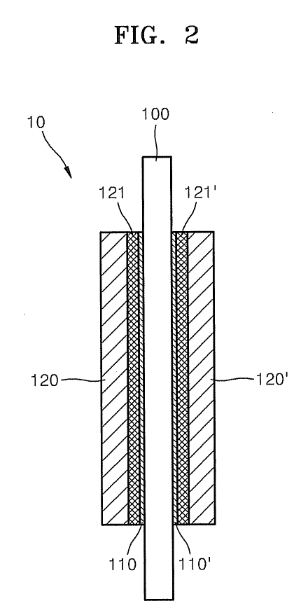

FIG. 1 is a perspective exploded view of a fuel cell 1 according to an embodiment of the present invention. FIG. 2 is a cross-sectional diagram of a membrane-electrode assembly (MEA) that forms the fuel cell 1 of FIG. 1.

Referring to FIG. 1, the fuel cell 1 includes two unit cells 11 that are supported by a pair of holders 12. Each unit cell 11 includes an MEA 10, and bipolar plates 20 disposed on lateral sides of the MEA 10. Each bipolar plate 20 includes a conductive metal, carbon or the like, and operates as a current collector, while providing oxygen and fuel to the catalyst layers of the corresponding MEA 10. Although only two unit cells 11 are shown in FIG. 1, the number of unit cells is not limited to two and a fuel cell may have several tens or hundreds of unit cells, depending on the required properties of the fuel cell.

As shown in FIG. 2, the MEA 10 includes an electrolyte membrane 100, catalyst layers 110 and 110′ disposed on lateral sides of the electrolyte membrane 100, first gas diffusion layers 121 and 121′ respectively stacked on the catalyst layers 110 and 110′, and second gas diffusion layers 120 and 120′ respectively stacked on the first gas diffusion layers 121 and 121′.

The electrolyte membrane 100 may include the composite membrane according to an embodiment of the present invention.

The catalyst layers 110 and 110′ respectively operate as a fuel electrode and an oxygen electrode, each including a catalyst and a binder therein. The catalyst layers 110 and 110′ may further include a material that may increase the electrochemical surface area of the catalyst.

The first gas diffusion layers 121 and 121′ and the second gas diffusion layers 120 and 120′ may each be formed of a material such as, for example, carbon sheet or carbon paper. The first gas diffusion layers 121 and 121′ and the second gas diffusion layers 120 and 120′ diffuse oxygen and fuel supplied through the bipolar plates 20 into the entire surfaces of the catalyst layers 110 and 110′.

The fuel cell 1 including the MEA 10 operates at a temperature of, for example, about 150° C. to about 300° C. Fuel such as hydrogen is supplied through one of the bipolar plates 20 into a first catalyst layer (for example, catalyst layer 110), and an oxidant such as oxygen is supplied through the other bipolar plate 20 into a second catalyst layer (for example, catalyst layer 110′). Then, hydrogen is oxidized into protons in the first catalyst layer, and the protons are conducted to the second catalyst layer through the electrolyte membrane (within the MEA 10, but not shown separately). Then, the protons electrochemically react with oxygen in the second catalyst layer to produce water and electrical energy. Hydrogen produced by reforming hydrocarbons or alcohols may be supplied as the fuel. Oxygen as the oxidant may be supplied in the form of air.

Hereinafter, a method of manufacturing a fuel cell using the composite membrane according to an embodiment of the present invention will be described. Electrodes, which each include a catalyst layer containing a catalyst and a binder, may be used.

The catalyst may be platinum (Pt), an alloy or a mixture of platinum (Pt) and at least one metal selected from the group consisting of gold (Au), palladium (Pd), rhodium (Ru), iridium (Ir), ruthenium (Ru), tin (Sn), molybdenum (Mo), cobalt (Co), and chromium (Cr). The Pt, the alloy, or the mixture may be supported on a carbonaceous support. For example, the catalyst may be at least one metal selected from the group consisting of Pt, a PtCo alloy, and a PtRu alloy. These metals may be supported on a carbonaceous support.

The binder may be at least one of poly(vinylidenefluoride), polytetrafluoroethylene, and a tetrafluoroethylene-hexafluoroethylene copolymer. The amount of the binder may be in the range of about 0.001 to about 0.5 parts by weight based on 1 part by weight of the catalyst. When the amount of the binder is within this range, the electrode catalyst layer may have strong binding ability to the support.

Any of the composite membranes according to the embodiments of the present invention, including a composite material of the compound of Formula 3 and an azole-based polymer, may be disposed between the two electrodes to manufacture the fuel cell.

Substituents in the formulae above may be defined as follows. As used herein, the term “alkyl” indicates a completely saturated, branched or unbranched (or a straight or linear) hydrocarbon. Non-limiting examples of the “alkyl” group include methyl, ethyl, n-propyl, isopropyl, n-butyl, isobutyl, sec-butyl, t-butyl, isopentyl, neopentyl, iso-amyl, n-hexyl, 3-methylhexyl, 2,2-dimethylpentyl, 2,3-dimethylpentyl, n-heptyl, and the like.

At least one hydrogen atom of the alkyl group may be substituted with a halogen atom, a C1-C20 alkyl group substituted with a halogen atom (for example, CCF₃, CHCF₂, CH₂F, CCl₃, and the like), a C1-C20 alkoxy group, a C2-C20 alkoxyalkyl group, a hydroxyl group, a nitro group, a cyano group an amino group, an amidino group, hydrazine, hydrazone, a carboxyl group or a salt thereof, a sulfonyl group, a sulfamoyl group, a sulfonic acid group or a salt thereof, a phosphoric acid or a salt thereof, a C1-C20 alkyl group, a C2-C20 alkenyl group, a C2-C20 alkynyl group, a C1-C20 heteroalkyl group, a C6-C20 aryl group, a C6-C20 arylalkyl group, a C6-C20 heteroaryl group, a C7-C20 heteroarylalkyl group, a C6-C20 heteroaryloxyl group, a C6-C20 heteroaryloxyalkyl group, or a C6-C20 heteroarylalkyl group.

The term “halogen atom” indicates fluorine, bromine, chloride, iodine, and the like. The term “C1-C20 alkyl group substituted with a halogen atom” indicates a C1-C20 alkyl group substituted with at least one halo group. Non-limiting examples of the C1-C20 alkyl group substituted with a halogen atom include monohaloalkyl, dihaloalkyl, or polyhaloalkyls including perhaloalkyl.

Monohaloalkyls indicate alkyl groups including one iodine, bromine, chloride or fluoride. Dihaloalkyls and polyhaloalkyls indicate alkyl groups including at least two identical or different halo atoms.

As used herein, the term “alkoxy” represents “alkyl-O—”, wherein the alkyl is the same as described above. Non-limiting examples of the alkoxy group include methoxy, ethoxy, propoxy, 2-propoxy, butoxy, t-butoxy, pentyloxy, hexyloxy, cyclopropoxy, cyclohexyloxy, and the like. At least one hydrogen atom of the alkoxy group may be substituted with substituents that are the same as those recited above in conjunction with the alkyl group.

As used herein, the term “aryl” group, which is used alone or in combination, indicates an aromatic hydrocarbon containing at least one ring. The term “aryl” may indicate, but is not limited to, a group with an aromatic ring fused to at least one cycloalkyl ring. Non-limiting examples of the “aryl” group include phenyl, naphthyl, tetrahydronaphthyl, and the like. At least one hydrogen atom of the “aryl” group may be substituted with substituents that are the same as those recited above in conjunction with the alkyl group.

As used herein, the term “heteroaryl group” indicates a monocyclic or bicyclic organic compound including at least one heteroatom selected from among nitrogen (N), oxygen (O), phosphorous (P), and sulfur (S), wherein the rest of the cyclic atoms are all carbon. The heteroaryl group may include, for example, one to five heteroatoms, and in some embodiments, may include a five- to ten-membered ring. In the heteroaryl group, S or N may be present in various oxidized forms.

Examples of the monocyclic heteroaryl group include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiaxolyl, 1,2,3-thiadiazolyl, 1,2,4-thiadiazolyl, 1,2,5-thiadiazolyl, 1,3,4-thiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, 5-pyrimidin-2-yl, and the like.

The term “heteroaryl” includes a heteroaromatic ring fused to at least one of an aryl group, a cycloaliphatic group, and a heterocyclic group. Examples of the bicyclic heteroaryl group include indolyl, isoindolyl, indazolyl, indolizinyl, purinyl, quinolizinyl, quinolinyl, isoquinolinyl, cinnolinyl, phthalazinyl, naphthyridinyl, quinazolinyl, quinaxalinyl, phenanthridinyl, phenathrolinyl, phenazinyl, phenothiazinyl, phenoxazinyl, benzisoqinolinyl, thieno[2,3-b]furanyl, furo[3,2-b]-pyranyl, 5H-pyrido[2,3-d]-o-oxazinyl, 1H-pyrazolo[4,3-d]-oxazolyl, 4H-imidazo[4,5-d]thiazolyl, pyrazino[2,3-d]pyridazinyl, imidazo[2,1-b]thiazolyl, imidazo[1,2-b][1,2,4]triazinyl, 7-benzo[b]thienyl, benzoxazolyl, benzimidazolyl, benzothiazolyl, benzoxapinyl, benzoxazinyl, 1H-pyrrolo[1,2-b][2]benzazapinyl, benzofuryl, benzothiophenyl, benzotriazolyl, pyrrolo[2,3-b]pyridinyl, pyrrolo[3,2-c]pyridinyl, pyrrolo[3,2-b]pyridinyl, imidazo[4,5-b]pyridinyl, imidazo[4,5-c]pyridinyl, pyrazolo[4,3-d]pyridinyl, pyrazolo[4,3-c]pyridinyl, pyrazolo[3,4-c]pyridinyl, pyrazolo[3,4-d]pyridinyl, pyrazolo[3,4-b]pyridinyl, imidazo[1,2-a]pyridinyl, pyrazolo[1,5-a]pyridinyl, pyrrolo[1,2-b]pyridazinyl, imidazo[1,2-c]pyrimidinyl, pyrido[3,2-d]pyrimidinyl, pyrido[4,3-d]pyrimidinyl, pyrido[3,4-d]pyrimidinyl, pyrido[2,3-d]pyrimidinyl, pyrido[2,3-b]pyrazinyl, pyrido[3,4-b]pyrazinyl, pyrimido[5,4-d]pyrimidinyl, pyrazino[2,3-b]pyrazinyl, pyrimido[4,5-d]pyrimidinyl, and the like. At least one hydrogen atom of the “heteroaryl” group may be substituted with substituents that are the same as those recited above in conjunction with the alkyl group.

The term “sulfonyl” indicates R″—SO₂—, wherein R″ is a hydrogen atom, alkyl, aryl, heteroaryl, aryl-alkyl, heteroaryl-alkyl, alkoxy, aryloxy, cycloalkyl, or a heterocyclic group.

The term “sulfamoyl” group refers to H₂NS(O₂)—, alkyl-NHS(O₂)—, (alkyl)₂NS(O₂)— aryl-NHS(O₂)—, alkyl-(aryl)-NS(O₂)—, (aryl)₂NS(O)₂, heteroaryl-NHS(O₂)—, (aryl-alkyl)-NHS(O₂)—, or (heteroaryl-alkyl)-NHS(O₂)—. At least one hydrogen atom of the sulfamoyl group may be substituted with substituents that are the same as those recited above in conjunction with the alkyl group.

The term “amino group” indicates a group with a nitrogen atom covalently bonded to at least one carbon or hetero atom. The amino group may refer to, for example, —NH₂ and substituted moieties.

The term “alkylamino group” also refers to an “alkylamino group” with nitrogen bound to at least one additional alkyl group, and “arylamino” and “diarylamino” groups with at least one or two nitrogen atoms bound to a selected aryl group.

Hereinafter, one or more embodiments of the present invention will be described in detail with reference to the following examples. These examples are not intended to limit the purpose and scope of the one or more embodiments of the present invention.

### Example 1

### Manufacture of Composite Membrane

SnO₂ and Al(OH)₃ were mixed in a Sn:Al molar ratio of 95:5 in tetrahydrofuran (THF), and were further mixed while grinding using a planetary ball mill at about 150 rpm for about 6 hours. Then, the ground mixed product was dried at about 50° C. for about 1 hour to evaporate the THF.

0.382 g of the SnO₂ and Al(OH)₃ mixed power were added to 5.0 g of a m-PBI solution (10 wt % in DMAc), and then mixed using a planetary ball mill at about 1500 rpm for about 6 hours to prepare a slurry of the composition. Then, the composition of slurry was cast on a glass substrate using a doctor blade, and then dried at about 90° C. for about 1 hour, and further at about 120° C. under vacuum for about 4 hours. Subsequently, the resulting membrane was removed from the surface of the glass substrate, thereby preparing a PBI/SnO₂—Al(OH)₃ composite membrane (first composite membrane).

The thickness of the PBI/SnO₂—Al(OH)₃ composite membrane was adjusted by changing an opening blade gap.

The PBI/SnO₂—Al(OH)₃ composite membrane was immersed in a 60° C., 85 wt % H₃PO₄ solution at about 60° C. overnight. Subsequently, the surface of the PBI/SnO₂—Al(OH)₃ composite membrane doped with H₃PO₄ was wiped using ethanol to remove the residual H₃PO₄ present on the surface of the composite membrane.

Afterward, the composite membrane was thermally treated in a mixed gas atmosphere of 10% hydrogen and 90% argon by volume at about 250° C. for about 4 hours, thereby preparing a composite membrane of PBI/Sn_{0.95}Al_{0.05}P₂O₇/phosphoric acid.

The amount of Sn_{0.95}Al_{0.05}P₂O₇ (hereinafter, “SAPO”) in the composite membrane was about 60 parts by weight based on 100 parts by weight of the total weight of the composite membrane, and the amount of PBI was about 40 parts by weight.

### Comparative Example 1

0.75 g of Sn_{0.95}Al_{0.05}P₂O₇ was added to 5.0 g of a m-PBI solution (10 wt % in DMAc), and then mixed using a planetary ball mill at about 1500 rpm for about 6 hours to prepare a slurry of the composition. Then, the composition of slurry was cast on a glass substrate using a doctor blade, and was dried at about 120° C. under vacuum for about 4 hours. Then, the resulting product was separated from the surface of the glass substrate.

### Comparative Example 2

### Manufacture of Phosphoric Acid-Doped PBI Membrane

5.0 g of a m-PBI solution (10 wt % in DMAc) was cast on a glass substrate using a doctor blade, and was dried at about 90° C. for about 1 hour, and further at about 120° C. under a vacuum for about 4 hours. Then, the resulting membrane was separated from the surface of the glass substrate, thereby resulting in a PBI membrane.

The PBI membrane was immersed in a 60° C., 85 wt % H₃PO₄ solution at about 60° C. overnight, followed by washing with ethanol, thereby preparing a phosphoric acid-doped PBI membrane.

### Evaluation Example 1

### Scanning Electron Microscopic (SEM) Analysis

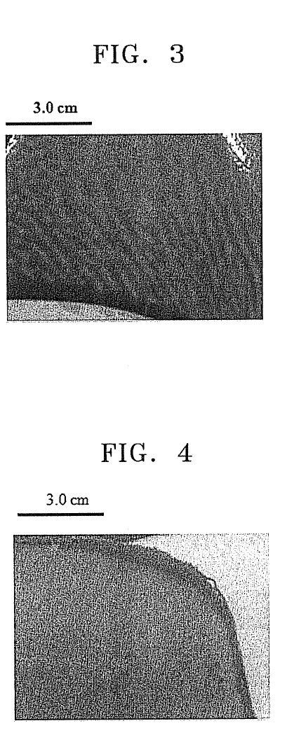

The first composite membrane and the composite membrane prepared according to Example 1, and the product prepared according to Comparative Example 1 were analyzed using scanning electron microscopy (SEM). The analysis results are shown in FIGS. 3 to 5.

As shown in FIG. 5, for the membrane of Comparative Example 1 formed using PBI and Sn_{0.95}Al_{0.05}P₂O₇, membrane formability was poor, and doping with phosphoric acid was impossible. These results are attributed to the strong binding (neutralization reaction) of a NH group of an imidazole ring of the alkaline PBI with protons of the acidic SAPO (Sn_{0.95}Al_{0.05}P₂O₇).

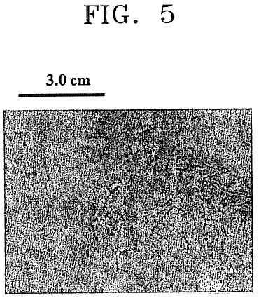

On the contrary, the first composite membrane (see FIG. 3) and the composite membrane (see FIG. 4) of Example 1 are found to have a stable membrane structure.

### Evaluation Example 2

### X-Ray Diffraction (XRD) Analysis

The first composite membrane prepared according to Example 1 was immersed in a 60° C., 85 wt % H₃PO₄ solution at about 60° C. overnight. Subsequently, the surface of the PBI/SnO₂—Al(OH)₃ composite membrane doped with H₃PO₄ was washed using ethanol to remove the residual H₃PO₄ present on the surface of the first composite membrane. Subsequently, the first composite membrane was thermally treated at about 250° C. in a mixed gas atmosphere of 10% hydrogen and 90% argon by volume.

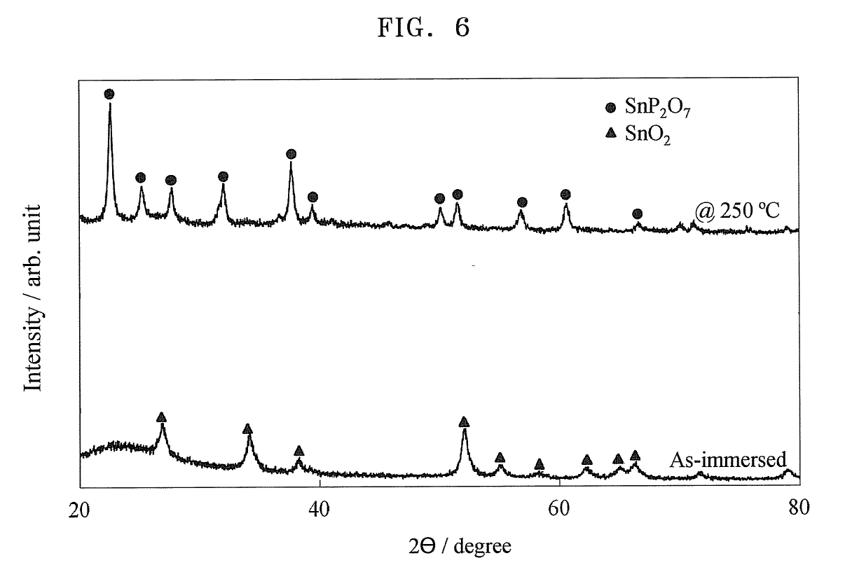

After the thermal treatment, the composite membrane was subjected to an X-ray diffraction analysis. The X-ray diffraction analysis was performed using a Rigaku Miniflex II diffractometer with Cu kα radiation (λ=1.5432 Å) at about 45 kV and about 20 mA. The X-ray diffraction analysis results are shown in FIG. 6. In FIG. 6, “As-immersed” indicates the state before the thermal treatment.

Referring to FIG. 6, single crystals of the SAPO are were found to have been formed. The average particle diameter of the SAPO was calculated using Scherrer's equation from a peak width at a half amplitude on the (200) plane in its X-ray diffraction spectrum. The average particle diameter of the SAPO was about 18 nm.

### Evaluation Example 3

### TG-DTA (Thermogravimetry Thermogravimetric—Differential Thermal Analysis)

Thermal characteristics of the composite membrane of Example 1 were analyzed by TG-DTA using a Shimadzu DTG-60 (available from SHIMADZU Co.) in which the temperature was increased from room temperature to about 550° C. at a rate of about 10° C./min.

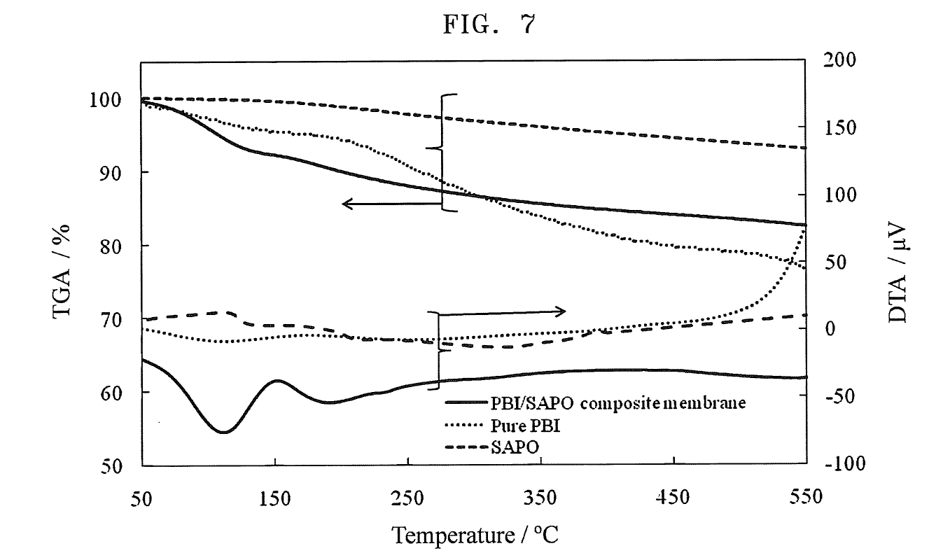

The analysis results are shown in FIG. 7. For comparison, in FIG. 7 the thermal characteristics of the composite membrane of Example 1 are shown along with thermal characteristic data of SAPO powder and an m-PBI membrane.

Referring to FIG. 7, the PBI membrane had a weight loss of about 5% at a temperature of from about 50° C. to about 130° C. and a small endothermic peak. This endothermic peak is attributed to desorption of adsorbed or absorbed water. A weight loss of about 5% was observed in the PBI membrane at about 450° C. or greater. This is attributed to the thermal decomposition of the PBI.

For the SAPO powder, although almost no weight loss was observed at up to about 150° C., a gradual weight loss up to about 5% was found from that temperature onward. The weight loss of the SAPO powder was attributed to desorption of water from the SAPO crystals.

The composite membrane of Example 1 had a slight weight loss in a temperature range of about 50° C. to 150° C., and two distinct endothermic peaks, one detected in the range of about 50° C. to 150° C. and the other in the range of about 150° C. to about 250° C. One of the two endothermic peaks in the temperature range of about 50° C. to about 150° C. is attributed to the desorption of absorbed or adsorbed water, and the other one in the temperature range of about 150° C. to about 250° C. is attributed to a dehydration reaction of the remaining H₃PO₄ in the composite membrane. The TG-DTA curve of the composite membrane of Example 1 at 250° C. or higher is similar to that of the SAPO powder, indicating that the PBI/SAPO composite membrane may not undergo severe damage up to at least about 500° C. due to the inclusion of the SAPO.

### Evaluation Example 4

### Scanning Electron Microscopic-Energy Dispersive X-Ray (SEM-EDX) Analysis

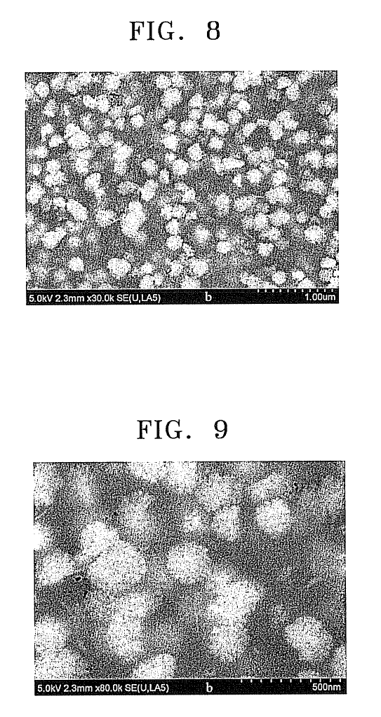

Morphology of the composite membrane of Example 1 was analyzed using a SEM equipped with an energy dispersive X-ray detector. SEM/EMX images of the membrane surface as a result of the analysis are shown in FIGS. 8 and 9. FIGS. 8 and 9 represent detailed information about a microstructure of the SAPO powder. FIG. 9 is a magnified portion of FIG. 8.

Referring to FIGS. 8 and 9, the SAPO powder has a particle diameter of about 300 nm, indicating that the SAPO powder corresponds to secondary particles, i.e., agglomerates of the SAPO crystals. The SAPO powder is found to have been homogeneously dispersed in PBI, forming SAPO—H₃PO₄ proton conduction paths.

### Evaluation Example 5

### Estimation of Phosphoric Acid Doping Level

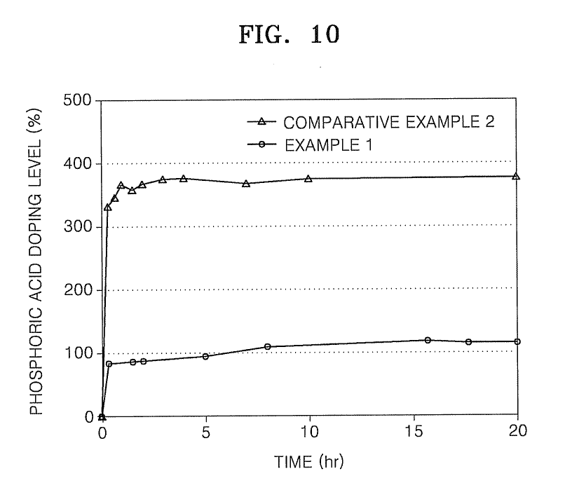

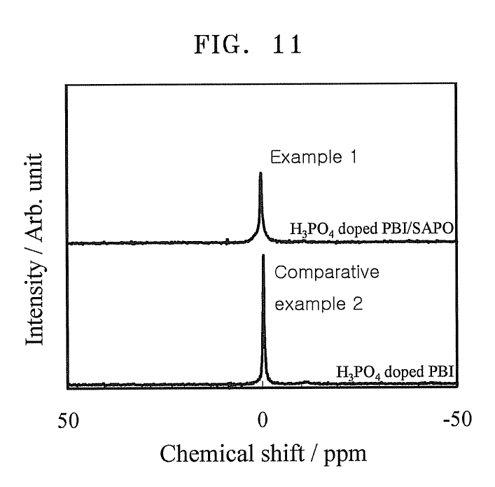

After the first composite membrane of Example 1 was immersed in an 85 wt % phosphoric acid solution at about 60° C. for about 15 hours, the phosphoric acid doping level was estimated according to Equation 2 below. The estimated phosphoric acid doping level with respect to time is shown in FIG. 10 and Table 1.

H₃PO₄ doping level (%)=(W−Wₚ)/Wₚ×100 [Equation 2]

In Equation 2, W and WP indicate the weights of the composite membrane after and before doping with the phosphoric acid, respectively.

FIG. 10 comparatively shows the phosphoric acid doping levels of the composite membrane of Example 1 and the m-PBI membrane of Comparative Example 2.

TABLE 1

| Example | Phosphoric acid doping level (%) |
|---|---|
| Example 1 | 114 |
| Comparative Example 2 | 375 |

Referring to FIG. 10, in the composite membrane of Example 1 the phosphoric acid doping level saturated to a maximum level after 15 hours, while in the m-PBI membrane of Comparative Example 2 the phosphoric acid doping level reached to a maximum level after 4 hours. This indicates that the SAPO powder inhibited permeation of the phosphoric acid into the PBI membrane.

### Evaluation Example 6

### Solid Nuclear Magnetic Resonance (NMR) Spectrum

The phosphorus and proton environments in the composite membrane of Example 1 and the phosphoric acid-doped PBI membrane of Comparative Example 2 were characterized by solid-state NMR spectroscopy.

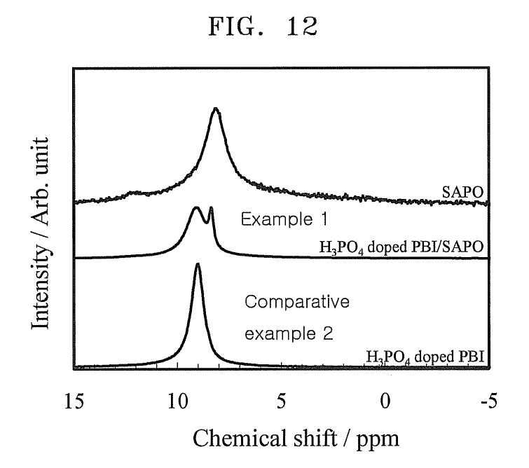

NMR spectra were measured using a Varian Unity Inova 300 NMR spectrometer at a pulse length of about 5 μs, a pulse-to-pulse decay time of about 10 s, and a sample spinning rate of about 9 kHz. ³¹P-NMR spectra for the composite membrane of Example 1 and the phosphoric acid-doped PSI membrane of Comparative Example 2 are shown in FIG. 11.

Referring to FIG. 11, the composite membrane of Example 1 and the phosphoric acid-doped PBI membrane of Comparative Example 2 exhibit a sharp resonance peak near 0 ppm. The peak intensity of the composite membrane of Example 1 is lower than that of the phosphoric acid-doped PBI membrane of Comparative Example 2, which indicates the phosphoric acid doping level of the composite membrane is lower than that of the phosphoric acid-doped PBI membrane.

1H-NMR spectra for the composite membrane of Example 1 and the phosphoric acid-doped PBI membrane of Comparative Example 2 are shown in FIG. 12. Referring to FIG. 12, the composite membrane of Example 1 has two distinct resonance peaks at about 9.2 ppm and about 8.3 ppm, while the phosphoric acid-doped PBI membrane of Comparative Example 2 shows only one peak at about 9.1 ppm. The peak at 8.3 ppm originates from protons incorporated into the SAPO powder.

### Evaluation Example 7

### Proton Conductivity

Proton conductivities of the composite membrane of Example 1 and the phosphoric acid-doped PBI membrane of Comparative Example 2 were measured by AC impedance spectroscopy using a Solartron SI 1260 impedance analyzer with gold electrodes placed on opposite sides of each membrane, in non-humidified air conditions, at an AC amplitude of about 20 mV and an AC voltage frequency of from about 100 kHz to about 0.1 Hz.

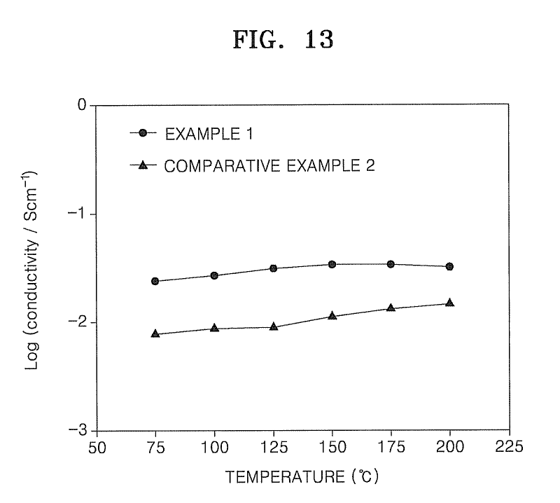

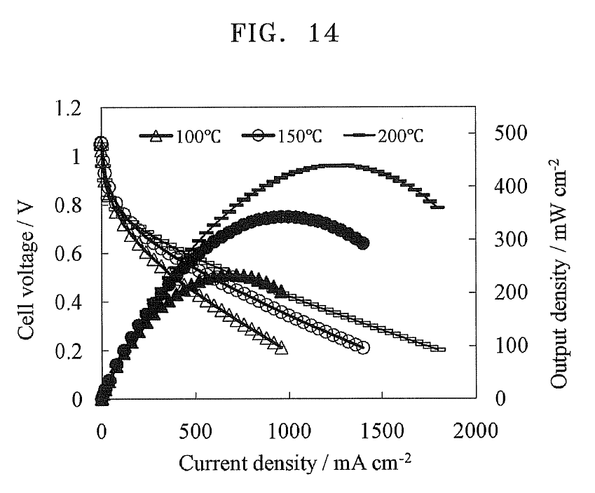

Proton conductivities of the composite membrane of Example 1 and the phosphoric acid-doped PBI membrane of Comparative Example 2 were measured. The results are shown in FIG. 13. Referring to FIG. 13, the composite membrane of Example 1 is found to have higher proton conductivity than the phosphoric acid-doped PBI membrane of Comparative Example 2.

### Evaluation Example 8

### Evaluation of Cell Performance

Using the composite membrane of Example 1 or the phosphoric acid-doped PBI membrane of Comparative Example 2 as an electrolyte membrane having a thickness of about 45 μm disposed between a cathode and an anode, cells were manufactured.

The cathode and anode were manufactured as follows for use in each cell. 4.5 g of a 10 wt % NAFION (available from Du Pont Inc.) aqueous dispersion were dropwise added to a solution of 3.0 g of Pt black in 3 ml of isopropyl alcohol, followed by mechanical agitation to prepare a composition for forming a cathode catalyst layer.

The composition for forming an electrode catalyst layer was coated on one surface of carbon paper to manufacture the cathode. The anode was manufactured in the same manner as in the manufacture of the cathode, except that, instead of Pt in the composition for forming a cathode catalyst layer, Pt/Ru black was used.

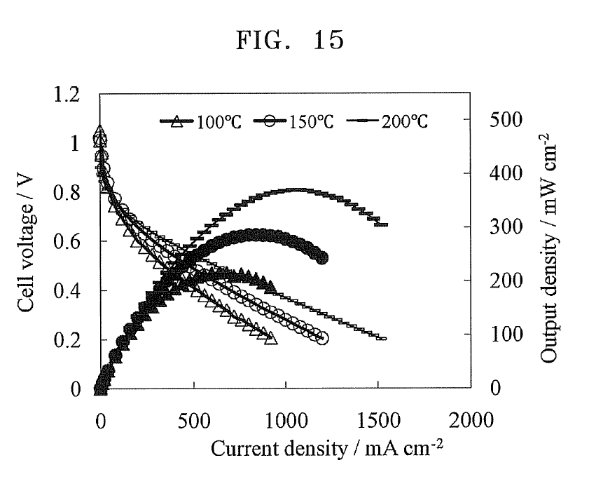

To test the performance of each fuel cell, non-humidified H₂ and O₂ were supplied to the anode and cathode at about 50 ccm and about 100 ccm, respectively, and the fuel cell was operated at about 100° C. to about 200° C. in non-humidified conditions to measure changes in cell voltage and output density with respect to current density. The results are shown in FIGS. 14 and 15.

From the results, an open circuit potential of about 1 V was obtained at the operating temperatures of each cell, which indicates that the crossover of H₂ or O₂ through the composite membrane is negligible. Referring to FIGS. 14 and 15, the current-voltage slopes decreased as the operating temperature increased from 100° C. to 200° C.

Referring also to FIGS. 14 and 15, the fuel cell with the composite membrane of Example 1 is found to have improved output density and cell voltage characteristics as compared to the fuel cell including the phosphoric acid-doped PBI membrane of Comparative Example 2.

### Evaluation Example 9

### Lifetime Evaluation

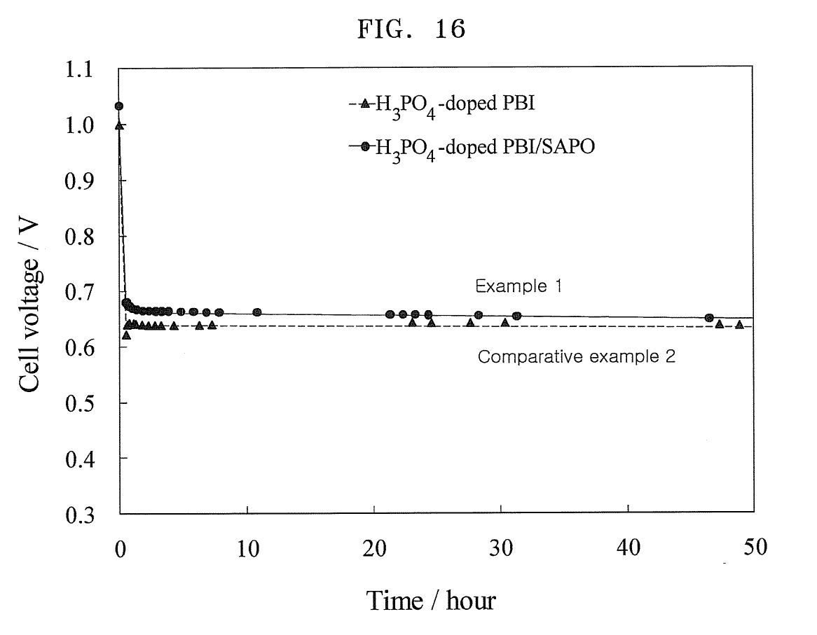

Lifetime characteristics of each fuel cell manufactured according to Evaluation Example 8, one including the composite membrane of Example 1, and the other including the phosphoric acid-doped PBI membrane of Comparative Example 2, were evaluated by measuring the change in cell voltage during discharging at about 150° C. The results are shown in FIG. 16.

As described above, according to the one or more of the above embodiments of the present invention, a composite membrane having high proton conductivity even with a low phosphoric acid doping level, and a fuel cell having excellent lifetime and cell performance characteristics including the composite membrane may be manufactured.

It should be understood that the exemplary embodiments described herein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A composition comprising:
a compound represented by Formula 1 below;
a compound represented by Formula 2; and
an azole-based polymer,
M¹A_{b} <Formula 1>
wherein, in Formula 1, M¹ is a tetravalent metallic element; A is chloride (Cl), hydroxide (OH), oxide (O), nitride (N), sulfate, or phosphate; and b is a number from 1 to 5,
M²_{c}A_{d} <Formula 2>
wherein in Formula 2, M² is at least one metal selected from the group consisting of a monovalent metallic element, a divalent metallic element, and a trivalent metallic element; A is chloride (Cl), hydroxide (OH), oxide (O), nitride (N), sulfate, or phosphate; c is a number from 1 to 2; and d is a number from 2 to 4.

2. The composition of claim 1, further comprising a phosphoric acid-based material.

3. The composition of claim 2, wherein the amount of the phosphoric acid-based material is from about 270 parts to about 500 parts by weight based on 100 parts by weight of the compound of Formula 1.

4. The composition of claim 1, wherein the compound of Formula 1 is a compound represented by Formula 1A:
M¹O_{b} <Formula 1A>
wherein, in Formula 1A, M¹ is a tetravalent metallic element; and b is a number from 1 to 3.

5. The composition of claim 1, wherein the compound of Formula 1 is at least one compound selected from the group consisting of tin oxide (SnO₂), tin chlorides (SnCl₄ and SnCl₂), tin hydroxide (Sn(OH)₄), tin (IV) hydrogen phosphate (Sn(HPO₄)₂), tungsten oxide (WO₂), tungsten chloride (WCl₄), molybdenum oxide (MoO₂), molybdenum chloride (MoCl₃), zirconium oxide (ZrO₂), zirconium chloride (ZrCl₄), zirconium hydrixide (Zr(OH)₄), titanium oxide (TiO₂), titanium sulfate (Ti(SO₄)₂), and titanium chlorides (TiCl₂ and TiCl₃).

6. The composition of claim 1, wherein the compound of Formula 2 is a compound represented by Formula 2A:
M²_{c}(OH)_{d} <Formula 2A>
wherein, in Formula 2A, M² is at least one metal selected from the group consisting of a monovalent metallic element, a divalent metallic element, and a trivalent metallic element; c is 1; and d is a number from 2 to 4.

7. The composition of claim 1, wherein the compound of Formula 2 is at least one compound selected from the group consisting of aluminum hydroxide, aluminum chloride, aluminum sulfate, aluminum oxide, aluminum nitride, indium hydroxide, indium chloride, antimony hydroxide, antimony chloride, lithium hydroxide, lithium oxide, lithium chloride, lithium nitrate, sodium hydroxide, sodium chloride, potassium hydroxide, potassium chloride, cesium hydroxide, cesium chloride, beryllium chloride, magnesium hydroxide, magnesium oxide, calcium hydroxide, calcium chloride, strontium hydroxide, strontium chloride, barium hydroxide, and barium chloride.

8. The composition of claim 1, wherein the amount of the azole-based polymer is from about 100 parts to about 170 parts by weight based on 100 parts by weight of the compound of Formula 1.

9. The composition of claim 1, wherein the amount of the compound of Formula 1 is from about 2 moles to about 99 moles based on 1 mole of the compound of Formula 2.

10. The composition of claim 1, wherein the azole-based polymer is 2,5-polybenzimidazole, poly(2,2′-(m-phenylene)-5,5′-bibenzimidazole) (m-PBI), or poly(2,2′-(p-phenylene)-5,5′-bibenzimidazole) (p-PBI).

11. A composite membrane comprising:
a composite containing a compound represented by Formula 3 below; and
an azole-based polymer:
M¹₁₋ₐM²ₐPₓO_{y} <Formula 3>
wherein, in Formula 3, M¹ is a tetravalent metallic element; M² is at least one metal selected from the group consisting of a monovalent metallic element, a divalent metallic element, and a trivalent metallic element; a satisfies 0≦a<1; x is a number from 1.5 to 3.5; and y is a number from 5 to 13.

12. The composite membrane of claim 11, further comprising a phosphoric acid-based material.

13. The composite membrane of claim 12, wherein the doping level of the phosphoric acid-based material is from about 100% to about 300%.

14. The composite membrane of claim 11, wherein the peak intensity of the composite material at 0 ppm in a ³¹P nuclear magnetic resonance (NMR) spectrum is lower than that of a phosphoric acid-based material-doped azole-based polymer.

15. The composite membrane of claim 11, wherein the peak of the composite in a¹H nuclear magnetic resonance (NMR) spectrum appears at 9.0±0.2 ppm and 8.2±0.2 ppm.

16. The composite membrane of claim 11, wherein the compound of Formula 3 has a particle diameter from about 10 nm to about 100 nm as calculated using Scherrer's equation from a peak width at a half amplitude on the (200) plane of the composite in an X-ray diffraction spectrum.

17. The composite membrane of claim 11, wherein the composite material exhibits a first endothermic peak at a temperature of about 50° C. to about 150° C., and a second endothermic peak at a temperature of about 150° C. to about 250° C. when analyzed by thermogravimetric-differential thermal analysis (TG-DTA).

18. The composite membrane of claim 11, wherein, in Formula 3, a is a number from about 0.01 to about 0.7.

19. The composite membrane of claim 11, wherein, in Formula 3, x is 2, and y is 7.

20. The composite membrane of claim 11, wherein the compound of Formula 3 is selected from the group consisting of Sn_{0.9}In_{0.1}P₂O₇, Sn_{0.95}Al_{0.05}P₂O₇, Ti_{0.9}In_{0.1}P₂O₇, Ti_{0.95}Al_{0.05}P₂O₇, Zr_{0.9}In_{0.1}P₂O₇, Zr_{0.95}Al_{0.05}P₂O₇, W_{0.09}In_{0.1}P₂O₇, W_{0.95}Al_{0.05}P₂O₇, Sn_{0.7}Li_{0.3}P₂O₇, Sn_{0.95}Li_{0.05}P₂O₇, Sn_{0.9}Li_{0.1}P₂O₇, Sn_{0.8}Li_{0.2}P₂O₇, Sn_{0.6}Li_{0.4}P₂O₇, Sn_{0.5}Li_{0.5}P₂O₇, Sn_{0.7}Na_{0.3}P₂O₇, Sn_{0.7}K_{0.3}P₂O₇, Sn_{0.7}Cs_{0.3}P₂O₇, Zr_{0.9}Li_{0.1}P₂O₇, Ti_{0.9}Li_{0.1}P₂O₇, Si_{0.9}Li_{0.1}P₂O₇, Mo_{0.9}Li_{0.1}P₂O₇, W_{0.9}Li_{0.1}P₂O₇, Sn_{0.7}Mg_{0.3}P₂O₇, Sn_{0.95}Mg_{0.05}P₂O₇, Sn_{0.9}Mg_{0.1}P₂O₇, Sn_{0.8}Mg_{0.2}P₂O₇, Sn_{0.6}Mg_{0.4}P₂O₇, Si_{0.5}Mg_{0.5}P₂O₇, Sn_{0.7}Ca_{0.3}P₂O₇, Sn_{0.7}Sr_{0.3}P₂O₇, Si_{0.7}Ba_{0.3}P₂O₇, Zr_{0.9}Mg_{0.1}P₂O₇, Ti_{0.9}Mg_{0.1}P₂O₇, Si_{0.9}Mg_{0.1}P₂O₇, Mg_{0.9}Mg_{0.1}P₂O₇, W_{0.9}Mg_{0.1}P₂O₇, Zr_{0.7}Mg_{0.3}P₂O₇, Ti_{0.7}Mg_{0.3}P₂O₇, Si_{0.7}Mg_{0.3}P₂O₇, Mo_{0.7}Mg_{0.3}P₂O₇, and W_{0.7}Mg_{0.3}P₂O₇.

21. A method of preparing a composite membrane, the method comprising:
supplying a phosphoric acid-based material to a first composite membrane comprising a compound represented by Formula 1 below, a compound represented by Formula 2 below, and an azole-based polymer; and
thermally treating the first composite membrane to which the phosphoric acid-based material has been supplied to form the composite membrane comprising a composite containing a compound represented by Formula 3 below and an azole-based polymer,
M¹A_{b} <Formula 1>
wherein, in Formula 1, M¹ is a tetravalent metallic element; A is chloride (Cl), hydroxide
(OH), oxide (O), nitride (N), sulfate, or phosphate; and b is a number from 1 to 5,
M²_{c}A_{d} <Formula 2>
wherein, in Formula 2, M² is at least one metal selected from the group consisting of a monovalent metallic element, a divalent metallic element, and a trivalent metallic element; A is chloride (Cl), hydroxide (OH), oxide (O), nitride (N), sulfate, or phosphate; c is a number from 1 to 2; and d is a number from 2 to 4, and
M¹₁₋ₐM²ₐPₓO_{y} <Formula 3>
wherein, in Formula 3, M¹ is a tetravalent metallic element; M² is at least one metal selected from the group consisting of a monovalent metallic element, a divalent metallic element, and a trivalent metallic element; a satisfies 0≦a<1; x is a number from 1.5 to 3.5; and y is a number from 5 to 13.

22. The method of claim 21, wherein the thermal treatment is performed in a mixed gas atmosphere containing about 10% to about 20% of hydrogen by volume and about 80% to about 90% of an inert gas by volume at a temperature of from about 150° C. to about 250° C.

23. The method of claim 21, wherein the first composite membrane is formed by mixing a compound represented by Formula 1 below, a compound represented by Formula 2 below, an azole-based polymer, and a first solvent to prepare a composition; and coating and drying the composition,
M¹A_{b} <Formula 1>
wherein, in Formula 1, M¹ is a tetravalent metallic element; A is chloride (Cl), hydroxide (OH), oxide (O), nitride (N), sulfate, or phosphate; and b is a number from 1 to 5, and
M²_{c}A_{d} <Formula 2>
wherein, in Formula 2, M² is at least one selected from the group consisting of a monovalent metallic element, a divalent metallic element, and a trivalent metallic element; A is chloride (Cl), hydroxide (OH), oxide (O), nitride (N), sulfate, or phosphate; c is a number from 1 to 2; and d is a number from 2 to 4.

24. The method of claim 23, wherein the coating and drying of the composition comprises coating the composition on a substrate, drying the coated composition to obtain the first composite membrane, and separating the first composite membrane from the substrate.

25. A fuel cell comprising the composite membrane according to claim 11.
